(19) United States
(12) Patent Application Publication
(10) Pub. No.: US 2010/0111345 A1
(43) Pub. Date: May 6, 2010

(54) MINIATURE STYLISH NOISE AND WIND CANCELING MICROPHONE HOUSING, PROVIDING ENCHANCED SPEECH RECOGNITION PERFORMANCE FOR WIRLESS HEADSETS

(76) Inventors: Douglas Andrea, Sag Harbor, NY (US); Stephan Auguste, Central Islip, NY (US); John Probst, Hauppauge, NY (US)

Correspondence Address: FROMMER LAWRENCE & HAUG, 745 FIFTH AVENUE- 10TH FL., NEW YORK, NY, 10151, US

(21) Appl. No.: 12/265,383

(22) Filed: Nov. 5, 2008

(51) Int. Cl. H04R 19/04

(52) U.S. Cl. 381/359

(57) ABSTRACT

A miniature microphone enclosure is provided for use with a wireless headset. The microphone enclosure provides superior noise and wind cancellation without any circuitry. Two sound ports and wind suppression material help minimize any noise attributable to wind or air. Moreover the microphone enclosure has a directivity such that the microphone does not have to be placed directly in front of a user's mouth.

### BACKGROUND OF THE INVENTION

1. Field of the Invention

The present invention relates to an acoustic noise canceling microphone enclosure.

2. Description of the Related Art

Mobile phones are used in all types of noisy real world environments as well as outside in the wind. New digital phone systems are now incorporating Automatic Speech recognition (ASR) software to provide a caller with an “automated attendant” to help navigate thorough phone list directories and obtain customer service through voice commands. In the past the phone user would have to use the touch pad to dial tone-pulse signals to navigate through complicated directory “trees”. Voice commands are both more convenient and a safety feature because the user does not have to look at the keypad and manually dial numbers to aces the desired information. When using a cell phone while driving, the user wants to keep his eyes on the road and hands on the wheel for safety. Therefore speech dialing is a preferred way to operate a cell network's directory assistance and other new information services.

ASR voice command software (automated attendants) are susceptible to noise. Noisy speech signals will result in false voice commands or no recognition by the automated attendant system. Thus, real world noisy environments result in poor performance of ASR software which creates customer dissatisfaction with the carrier's service. Most cell phones do not have noise cancellation technologies to enhance these fragile but powerful ASR automated attendant software services.

Conventionally, wireless headsets with a boom feature can contain a close talking pressure gradient microphone element in a large housing. The housing typically has a main acoustic opening on the front and smaller opening directly out the back of the microphone element.

Traditionally, a foam wind cover to is used to block the unwanted wind pressure on to the internal diaphragm of the microphone element. Wind pressure will result in drastically moving the microphone pick up diaphragm and translate into predominantly low frequency noise on the voice signal. It is desirable to reduce the wind noise as well as acoustic noise. The foam device typically has to be very large to cover the entire microphone tip assembly. On more complex two-microphone Bluetooth headsets that use digital signal processing (DSP) technology, a high-pass filter is used upon detection of wind turbulence. Therefore using such a DSP solution consumes battery power and distorts the voice quality.

Therefore, how the microphone element is acoustically housed and placed in relation to the mouth can greatly effect the noise canceling performance of the pressure-gradient microphone device and its ability to pick up the voice signal adequately and provide a desirable signal to noise ratio.

### SUMMARY OF THE INVENTION

Thus, there is a market need for a cell phone accessory with noise canceling technology for use in noisy mobile environments. Preferably, such an accessory can be a Bluetooth headset that could be used with any number of different manufacturers cellular handsets. Successive generations of Bluetooth headsets are growing increasingly small so the present invention would also have to be sized accordingly as not to look to obtrusive on the headset device.

The object of the present invention is to provide a miniature acoustic noise canceling microphone enclosure. It is also an object of the present invention to reduce wind noise and help limit the total amount of noise received by the microphone in the outside mobile environment.

It is also an object of the present invention to provide a cell phone headset accessory that is fashionable and unobtrusive to the wearer, while the user is going about his every day life.

Embodiments of the present invention provide maximum voice transmission, noise reduction, and wind suppression, while also being fashionable, compact and out of the way from in front of the user's mouth.

### BRIEF DESCRIPTION OF THE DRAWINGS

The above and other objects, features and advantages of the present invention will be more apparent from the following detailed description taken in conjunction with the accompanying drawings, in which:

FIG. 1 is a diagram of a microphone headset found in the prior art.

FIG. 2 is a top view diagram of a headset according to an embodiment of the present invention.

FIG. 3 is a diagram of multiple views of the microphone capsule and headset boom according to one embodiment of the present invention.

FIG. 4 is a diagram of a cross-section of one-half of the microphone capsule according to one embodiment of the present invention.

FIG. 5 is a diagram of a cross-section of a second half of the microphone capsule according to one embodiment of the present invention.

FIG. 6 is a diagram of a user wearing a microphone headset according to an embodiment of the present invention.

FIG. 7 is a graph of a polar plot showing the directivity of a microphone capsule according to one embodiment of the present invention.

FIG. 8 is a diagram of a testing setup of a wireless Bluetooth headset using a microphone capsule according to one embodiment of the present invention.

FIG. 9 shows frequency response of wave files used in testing an embodiment of a microphone capsule according to the present invention.

FIG. 10 shows output response of a wireless headset using a microphone capsule according to an embodiment of the present invention.

### DETAILED DESCRIPTION OF THE PREFERRED EMBODIMENT

Hereinafter, preferred embodiments of the present invention will be described with reference to the accompanying drawings. It should be noted that the similar components are designated by similar reference numerals although they are illustrated in different drawings. Also, in the following description, a detailed description of known functions and configurations incorporated herein will be omitted when it may obscure the subject matter of the present invention.

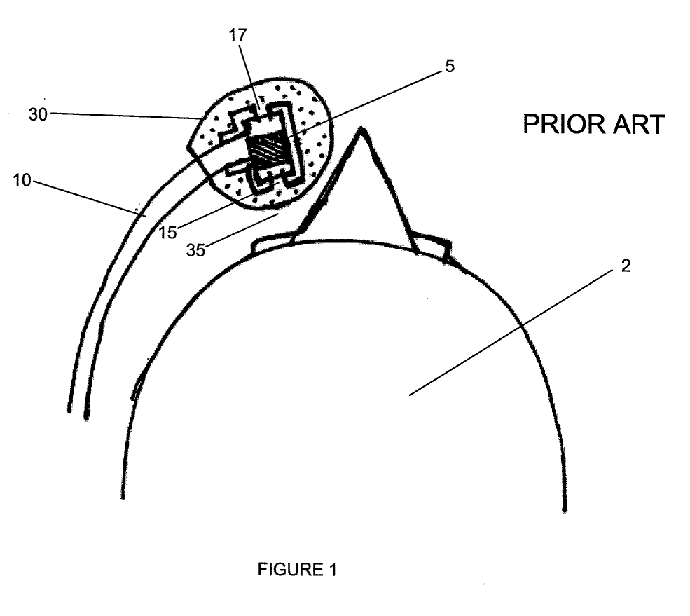

The present invention proposes a microphone headset having a acoustic noise canceling microphone enclosure. A conventional boom headset worn on a user head 2 is shown in FIG. 1. A boom 10, is connected to a pressure gradient microphone 5, enclosed in a large housing. Usually, two sound paths lead to the microphone 5. A near field sound port 15, typically is positioned in front of a mouth in the direct voice path 35. A second, far field sound port 17, is positioned typically away and opposite of the near-field sound port 15, as shown in FIG. 1. Typically a wind-noise suppression material 30 would surround the gradient microphone. Such material typically is thick and dense so as to act as a buffer maze of small pockets in order to diffuse the wind pressure and prevent any pressure reaching the gradient microphone element directly. Foam is one such type of suitable material. “Open cell” wind foam material, is categorized in Pours Per inch or PPI. Typically the more the PPI, the better the wind suppression performance. Other suitable materials include acoustically transparent cloth using synthetic materials such as nylon.

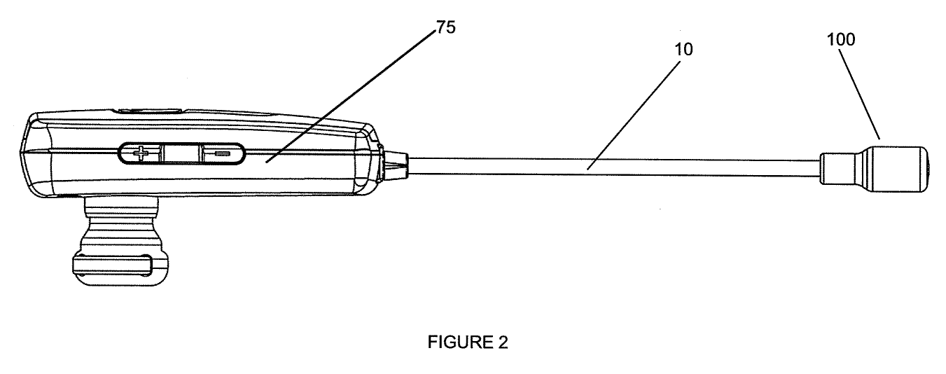

The present invention proposes microphone enclosure in a headset-boom configuration that is smaller in size compared to prior art devices. FIG. 2 is a top-view diagram of an embodiment of the present invention which shows a wireless headset containing a transmitter unit 75, a boom 10, and a microphone enclosure 100.

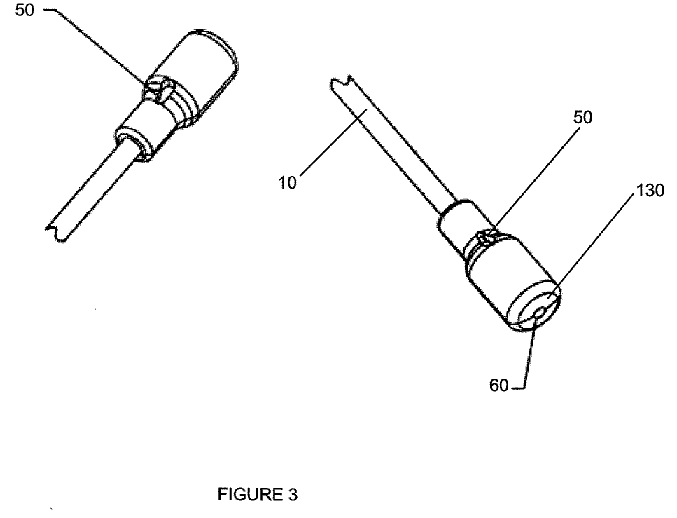

FIG. 3 illustrates multiple outer views of the microphone enclosure 100 according to one embodiment of the present invention. According to one embodiment, the microphone enclosure 100 typically has a circular cylindrical-like shape, though other configurations are possible. Furthermore the area or diameter of the enclosure can vary. For instance FIG. 3 shows the end of the enclosure having a larger diameter than the part of the enclosure around or near the boom 10.

According to one embodiment, the microphone enclosure is a cylindrical capsule approximately 10 mm long by 6 mm in diameter (at its widest) other shapes, dimensions? The enclosure 100 has at least two sound ports: a front sound port 60 and a side sound port 50. According to an embodiment, the front sound port 60 is centered on a flat-end 130 of the microphone enclosure 100. However, in other embodiments, the enclosure does not necessarily have a flat-end 130, or that the front sound port 60 necessarily is centered. In other embodiments, there may be more than one sound hole or aperture on the front end of the enclosure 100. The side sound port 50, in some embodiments, resides closer to the boom 10, than the flat-end 130 or a tip of the enclosure. The side sound port is an angle with the front sound port 60 that in some embodiments ranges from about 90° perpendicular to about 135° with respect to the direction that the front sound port 60 faces. This angle may vary to improve acoustic performance. For instance, the angle between the side sound port 50 and the front sound port 60 can be about 90°, about 95° . . . (by 5° increments up to 135°). In theory the angle could be between 0° and 180°. Similarly, in other embodiments there may be more than one side sound port. The at least two sound ports help focus or direct the sensitivity of the microphone.

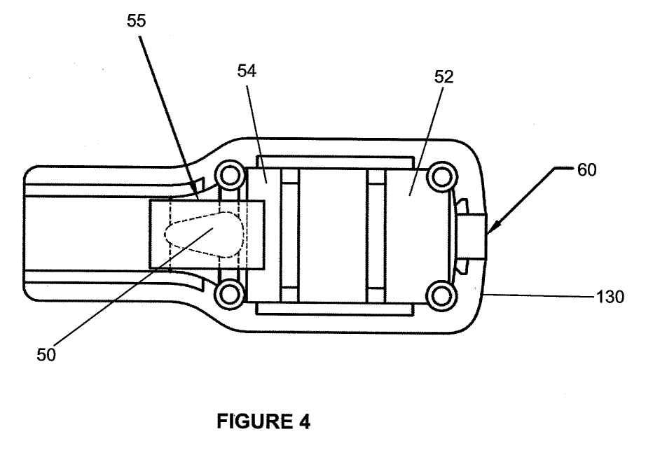

FIG. 4 shows one side of the cross-section of the microphone enclosure 100 accord to one embodiment. The microphone capsule 100 is a direct linear extension of the boom and is parallel to the boom direction. In FIG. 4, a side sound port 50 can be shaped like a pear or like an egg. In other embodiments, the side port 50 can take many other shapes, such as a circular aperture, a square, etc. The side port 50 is either filled or covered from the inside of the enclosure 100 by a wind suppression material 55. As explained earlier, this material may be foam or any other suitable material such as acoustically transparent cloth as described above. The presence of the wind suppression material 55 helps disrupt any air pressure turbulence near the acoustic surface of the microphone. Small volume cavities, 52 and 54 are placed inside the enclosure 100 between each acoustic port in the housing and the acoustic openings of the internal microphone. The internal cavities act as a wind pressure buffer zone.

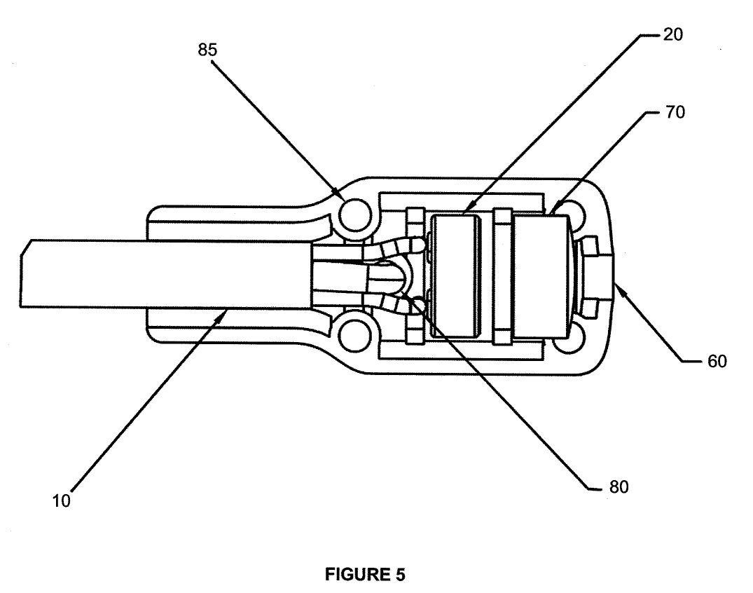

FIG. 5 shows the opposite side of the cross-section of FIG. 4 according to one embodiment. FIG. 5 shows the front sound port 60 aligned to be directly facing the internal pressure gradient microphone 20. According to one embodiment, the microphone 20 can be very small. For instance, the microphone can be about 4 mm the microphone 20 and can also range in size from about 3 mm to about 6 mm. A front wind suppression material 70, may be positioned in the internal cavity 52 between the front sound port 60 and the microphone 20. Again, this material may take the form of a foam disc, but other types of materials and shapes may also be appropriately used to disrupt any air pressure turbulence. In one embodiment, the foam disc may be approximately 2-3 mm thick, with a diameter of 4-6 mm. A back wind suppression material 72, such as a foam disc may also be placed behind the microphone 20 and have similar dimensions.

According to embodiments of the invention, the two sound holes, are very small so minimal wind exposure is present. It is also more difficult for wind pressure to enter a small hole than the desired acoustic vibrations. Therefore the holes can be minimal so less wind pressure can impinge on the air pressure buffer zones. The buffer zones were found to work so well acoustically, as well as for wind suppression that only a very small amount of wind foam was required to optimize performance. The size of the holes can range from 1 mm to 3 mm.

FIG. 5 also shows the microphone 20 connected to one or more or wires 80 that run through the boom 10. The microphone enclosure 100 in some embodiments may contain one or more guide holes 85, which can be used to connect the enclosure together if it is manufactured in several pieces. In other embodiments, the microphone enclosure may be manufactured as one piece via injection molding. The shell of the microphone enclosure 20, may also be any suitable material that supports the elements and is durable, for example plastic or composite.

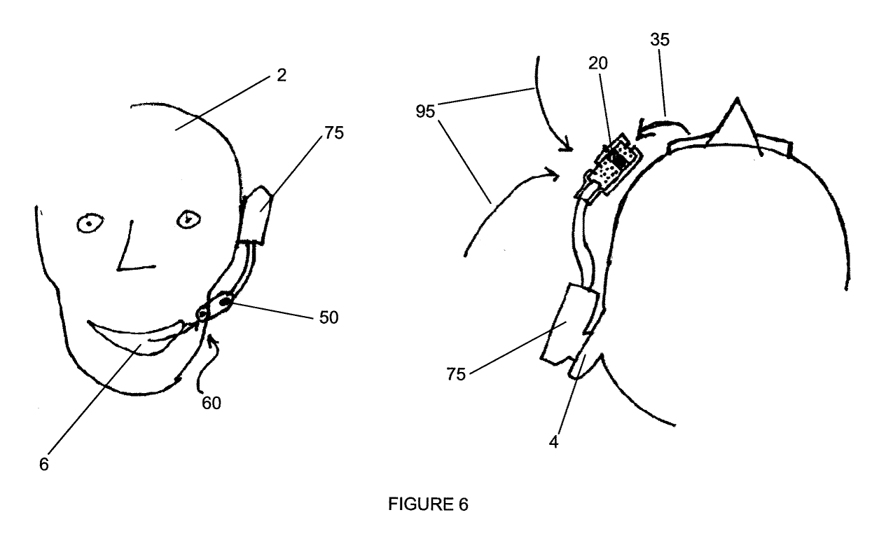

According to an embodiment of the present invention, the acoustic or sound ports 50 and 60 of the microphone enclosure 100 direct the microphone acoustic sensitivity. FIG. 6 shows a front and top view of a user head 2 wearing the headset according to an embodiment of the present invention. As shown in FIG. 6 the microphone enclosure 100 is positioned slightly behind and adjacent the mouth. The front sound port 60 points forward in the direction of acoustic transmission path generated from the output pressure from the side of the mouth. The front sound port points to maximally capture the sound pressure level. The enclosure's front sound port opening 60 typically resides at a corner of the mouth proximally 12 cm from the center of an ear 4 (on an average adults head). The front sound port 60 receives and directs sound from the near-field, or the close-talking path 35. The side sound port 50 receives sound from the far-field 95 as shown in FIG. 6.

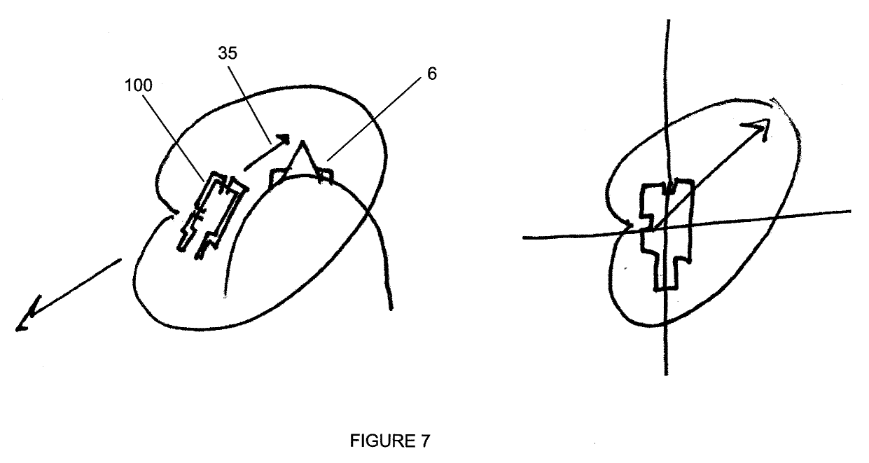

Based on the microphone enclosure 100 according to an embodiment of the present invention, a polar plot as shown in FIG. 7 is produced. The polar plots show a peak at 45°. Therefore, when the headset is worn as shown in FIG. 6, the microphone directivity will advantageously be in the direction of the user's mouth 6. Therefore, the microphone enclosure 100 does not need to be angled into the cheek or mouth 6, and does not need to be placed directly in front of the mouth. Another benefit from the enclosure 100 being off to the side of the mouth 6 is that it would not receive breath popping noises emanating from the mouth. Also when the microphone is not in front of the mouth 6, a user can easily drink or eat while using the “side talking” boom microphone of the present invention.

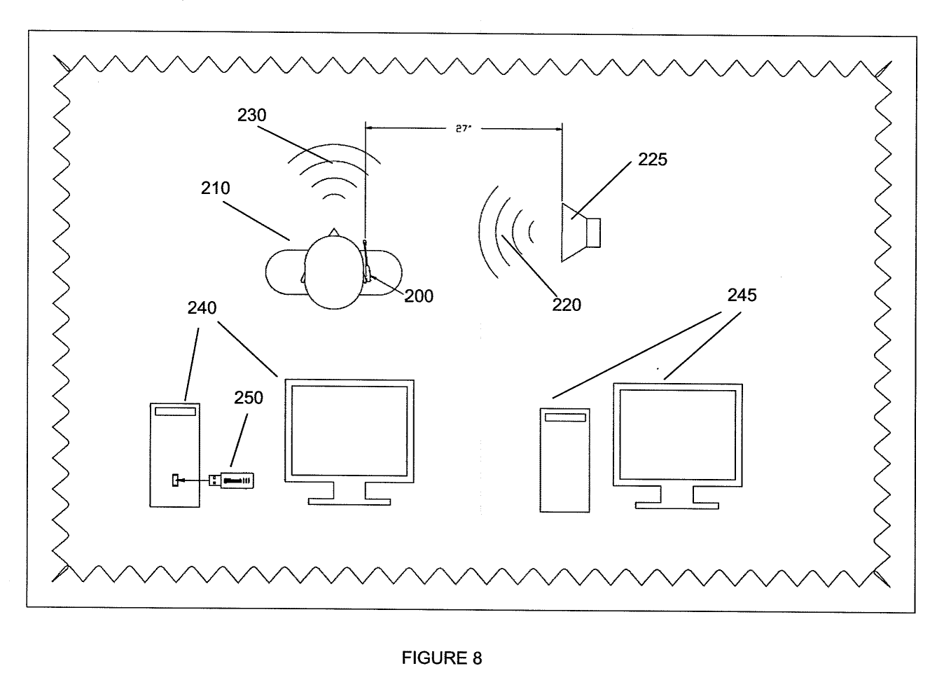

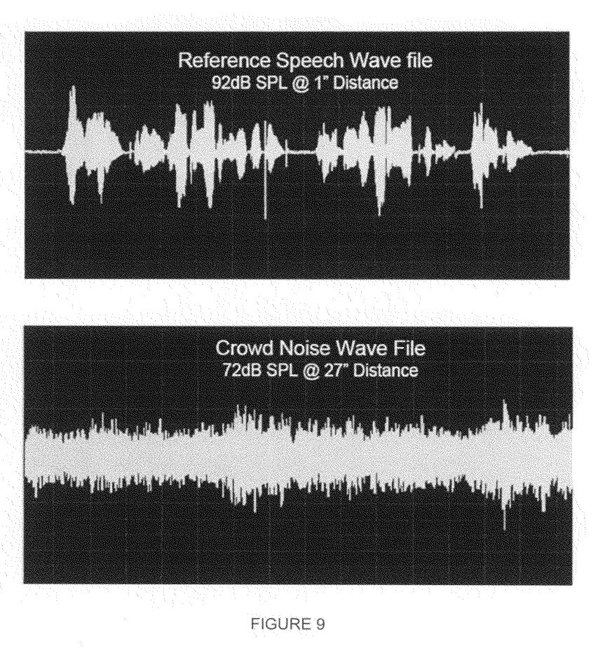

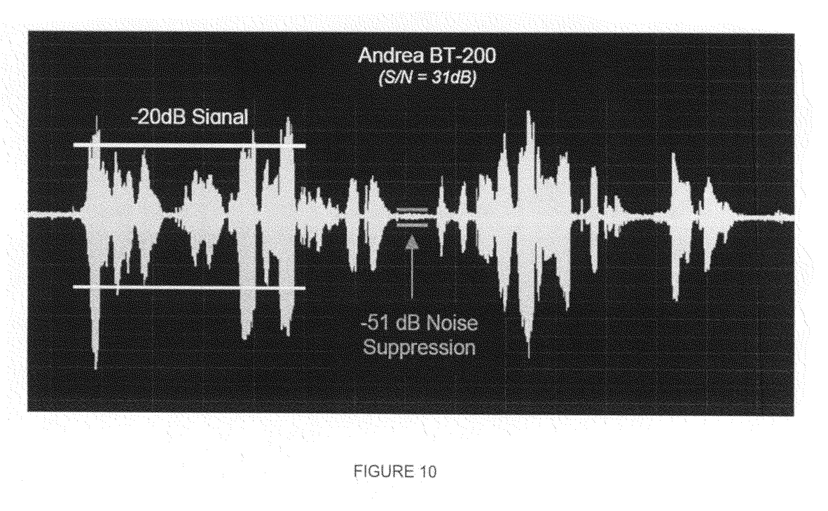

FIG. 10 shows tests results of using the microphone enclosure according to an embodiment of the present invention. In the test setup as show in FIG. 8 Bluetooth devices 200 are placed in a fixed position on the right Right Ear of a Bruel & Kjaer (“B&K”) Head and Torso Simulator 210. A generated wave file of “Crowd Noise” 220 (obtained from CBS Audio file sound effects library) is played through a speaker 225 placed 27″ away from the Bluetooth device 200 on the B&K Head and Torso Simulator 210. The “Crowd Noise” 220 output is calibrated and adjusted at fixed setting of 72 dB SPL, measured at the Bluetooth device 200 under test. Two generated “Speech” wave file (15 Seconds and 3 Minutes) text readings are played through the B&K Head and Torso Simulator 210. The “Speech” output 230 is calibrated and adjusted for 92 dB SPL maximum at 1″ distance away from Mouth Simulator. FIG. 9 shows a graph of the “Speech” wave file and the “Crowd Noise” file.

The setup used a Dell Notebook computer as the source of the 1411 kbps high quality speech files that were played from the PC 245 through a B&K artificial head and torso simulator 210. Noise files, when needed, are played from the PC 245 through an amplifier then through an amplified off axis speaker. To ensure repeatable results the speech and noise files are combined into a single stereo file that is played left channel to the head and torso simulator and right channel to the off axis speaker. The Device Under Test (DUT) is connected to a second computer 240 that is configured for speech recognition. The Dragon Naturally Speaking Version 9 software application is used on the computer 240 paired with the Bluetooth devices 200 to record the transcribed text reading. The input for all tests is via an Andrea Bluetooth USB Audio Adapter 250 with a full duplex audio input and output.

A source of variability in testing is sound pressure level measurements. There are two main “weightings” for Sound Pressure Level (SPL): “A” weighting and “C” weighting. “A” weighting compensates for the non-linear response of the human ear, while “C” weighting is a flatter response. The response of the human ear to sound is worse at low and high frequencies. The two weightings will give different results depending on the frequency distribution of the sound. In an office environment, significant content can be missed by “A” weighting that humans cannot hear, but the microphone will pick-up. The microphone and speech engine will be affected by this inaudible noise so it was considered in the test. Low frequency blower and air exchanger noise is of particular concern, as it is difficult to hear. All Andrea SPL readings use “C” weightings. It is believed that “C” weighting reflects more accurately the range of sounds the microphone picks up. Andrea PureAudio BT-200 Noise Canceling Bluetooth Headset results indicated a 31 dB of signal to noise ratio for suppression of background “Crowd Noise” imposed into the microphone while speech remains clear and undistorted. The results are shown in FIG. 10.

The miniature capsule with unique acoustic porting for noise canceling boom microphone according to embodiments of the present invention provides superior performance (providing 20 dB noise reduction @200 Hz). The microphone according to an embodiment of the present invention provides better acoustic noise than with other digital processing techniques that utilize software algorithms to reduce these problems. Compared to standard Bluetooth headsets with no wind cancellation, the microphone enclosure according to an embodiment of the present invention provides 11.5 dB of wind noise reduction. Without the foam, the device would have 0 dB of wind noise reduction. Therefore the improved invention version has 11.5 dB of wind noise reduction. Other advantages include no voice frequency distortion as found with most digital NR software algorithms. Other advantages of the present invention include the power consumption, as the noise and wind reduction of the enclosure 100 of the present invention requires no DSP or other electronic circuitry. Therefore, the battery life of the headset can be dedicated to the transmitter unit and thus provide much longer talk times between charges than with digital processing devices with same battery size/type (8˜10 Hrs talk time, 150 Hrs standby). Furthermore the input device can be relatively light and small while not interfering with eating and drinking while wearing and in use.

While illustrative embodiments of the invention have been described above, it is, of course, understood that various modifications will be apparent to those of ordinary skill in the art. Such modifications are within the spirit and scope of the invention, which is limited and defined only by the appended claims.

What is claimed:

1. A microphone capsule comprising:
a first sound hole positioned at one end of the capsule facing a first direction;
a second sound hole facing a second direction different than the first direction;
a microphone aligned in a direction parallel to the direction the first sound hole faces; and
wind cavity buffer zones located in front and back of the microphone;

2. The microphone capsule of claim 1, wherein the wind cavity buffer zones contain foam to reduce wind turbulence near the microphone.

3. The microphone capsule of claim 1, wherein the angle between the first direction and the second direction determine the microphone sensitivity.

4. The microphone of claim 1, wherein the angle between the first direction and second direction is between 45° and 180°.

5. The microphone of claim of claim 4, wherein the angle between the first direction and second direction is about 90°.

6. The microphone capsule of claim 1, wherein the second sound hole is pear shaped.

7. The microphone capsule of claim 1, wherein the second hole is filled or covered with wind suppression material.

8. The microphone capsule of claim 1, wherein the outer housing is made of plastic.

9. The microphone capsule of claim 1, wherein the capsule has a cylindrical-like shape.
